(19) United States
(12) Patent Application Publication
(10) Pub. No.: US 2015/0169543 A1
(43) Pub. Date: Jun. 18, 2015

(54) METHOD AND AN APPARAUS FOR INSTRUCTION SET TRANSLATION USING FINITE STATE AUTOMATA

(71) Applicant: Brno University of Technology, Brno (CZ)

(72) Inventors: Tomas Hruska, Brno (CZ); Zdenek Prikryl, Brno (CZ); Adam Husar, Brno (CZ)

(73) Assignee: BRNO UNIVERSITY OF TECHNOLOGY, Brno (CZ)

(21) Appl. No.: 14/103,845

(22) Filed: Dec. 12, 2013

(51) Int. Cl. G06F 17/28

(52) U.S. Cl. CPC G06F 17/28

(57) ABSTRACT

A method and a system embodying the method for instruction translation, comprising providing a first finite state automaton; providing a second finite state automaton communicatively coupled with the first finite state automaton via a one-to-many relation; providing the instruction to be translated to one of the first or the second finite state automaton; and receiving a translated instruction from the other of the first or the second finite state automaton is disclosed.

### BACKGROUND

1. Field

The present disclosure relates to finite state automata. More particularly, this invention is directed toward a use of finite state automata for instruction set translation.

2. Description of Related Technology

A central processing unit (CPU) is a hardware entity that carries out instructions of a computer program by performing basic arithmetical, logical, and input/output operations. A CPU comprises a processor core implementing an instruction set architecture. Such CPU may comprise standard processor core, e.g., Microprocessor without Interlocked Pipeline Stages (MIPS) or Advanced RISC Machine (ARM). Should an instruction set of the standard architectures not be sufficient for design requirements of a specific application, a processor core with instruction set tailored to benefit the specific application is used. Such a processor core is known as Application-specific Instruction Set Processor (ASIP).

Programs written in an instruction set may be represented in two forms, an assembly language, comprising human readable text, and a machine code, comprising a binary code. Assembly language instructions usually consist of elements comprising an operation code (opcode) mnemonic followed by one or more operands, i.e., a list of data, arguments and/or parameters. The machine code comprises binary representation of the opcode, the list of the data, the arguments and/or the parameters that the CPU can execute. Opcode is the portion of the assembly language instruction or the machine code instruction that specifies the operation to be performed. The translation from an assembly language to a machine code is carried out by an assembler; the inverse translation is carried out by a disassembler. Because an instruction set is processor core specific, an assembler and disassembler, collectively translator, is, likewise processor core specific.

One approach to translator's implementation is use of a Finite State Transducer 100 as depicted in FIG. 1. The Finite State Transducer 100 comprises a plurality of states 102, numbered in consecutive manner, including the initial state 102_S and the final state 102_F. An input of a symbol at the Finite State Transducer 100 causes generation of a binary symbol stream at the output and makes a transition from one state to another state along an edge 104. Thus, by means of an example, consider the Finite State Transducer 100 being in the initial state 102_S. Upon entry of a symbol a at an input, a binary stream equivalent to an empty symbol e is generated at the output, and the Finite State Transducer 100 makes a transition from the initial state 102_S alone the edge 104_2 to the state 102_2, where the Finite State Transducer 100 awaits another symbol. Upon entry of a next symbol d at the input, a binary stream equivalent to an empty symbol e is generated at the output, and the Finite State Transducer 100 makes a transition from the state 102_2 alone the edge 104_4 to the state 102_4, where the Finite State Transducer 100 awaits another symbol. Upon entry of a next symbol d at the input, the Finite State Transducer 100 recognizes that an assembly opcode add has been entered, generates and binary stream 0011, corresponding to the assembly opcode add, and the Finite State Transducer 100 makes a transition from the state 1024 alone the edge 104_6 to the state 102_6, where the Finite State Transducer 100 awaits another symbol. When the final state 102_F is reached, the translation is finished.

A person of ordinary skills in the art will understand from the foregoing that the term transition and the term edge are interchangeable, expressing the notion of a change from one state into another state.

A disadvantage of a Finite State Transducer is that an input is processed in a symbol-by-symbol manner, which requires more memory and may increase implementation complexity. Additionally, upon receiving the input, the output is immediately generated, which prevents operands shuffle. This causes problem in implementation because processor cores may require, e.g., for reason of hardware implementation efficiency, that the order of the instruction's operands in assembly language is different from the order of operands in machine code. By means of an example, consider an assembly language instruction add r0, r1, 9. The Finite State Transducer 100 will generate a corresponding machine code instruction 0011000000011001, because assembly opcode add corresponds to binary string 0011, operand r0 corresponds to binary string 0000, operand r1 corresponds to binary string 0001, and intermediate operand (imm) 9 corresponds to binary string 1001. However, the processor core may require that the intermediate operand 9 be received before the operand r0, thus requiring binary machine code instruction 0011100100000001.

The above-noted disadvantages were addressed in a document by Hru\check{s}ka, T., Kola, D., Luká\check{s}, R., Záme\check{c}niková, E., entitled Two-Way Coupled Finite Automaton and Its Usage in Translators, In: New Aspects of Circuits, Heraklion, GR, WSEAS, 2008, s. 445-449, ISBN 978-960-6766-82-4, ISSN 1790-5117. FIG. 2 depicts a conceptual structure of two Lazy Finite State Automata (LFSA) 200_1 and 200_2 communicatively coupled together via a bijective function. The bijective function communicative coupling is depicted by double-arrowed broken lines. Such a structure enables a string of symbols to be used as an input. The string can be an empty string or a string of any length. There is one special string for immediate operand, imm. In case of an assembly language, imm represents an arbitrary number, signed or unsigned, e.g., −10, 52. In case of a machine code instruction, imm represents a binary number coded by a given number of bits. The number of bits is determined by the processor core. If the assembly language number utilizes fewer bits, then the binary number is sign extended, in the case of signed number, or zeros are added from the left, in the case of unsigned number. If the assembly language number utilizes more bits, then the binary number is truncated. Each LFSA 200_1, 200_2, comprises a plurality of states 202, 206, numbered in consecutive manner, including an initial state 202_S, 206_S and a final state 202_F, 206_F. An input of a string of symbol at the LFSA 200_1, 200_2 causes a transition from one state to another state along an edge 204, 208.

When a translation is desired one of the LFSAs, the receiving LFSA, is activated, and instead of generating an output, the activated LFSA stores a set of transitions used to transition from the initial state to the final state and used immediate operands. When the activated LFSA reaches the final state, the other one of the LFSAs, the generating LFSA, is activated and by the bijective function communicatively coupling the receiving LFSA with the generating LFSA, the set of a used transitions, and the used immediate operands, the generating LFSA generates the translation. As depicted in FIG. 2, the LFSA 200_1 is a receiving LFSA and the LFSA 200_2 is a generating LFSA for translation from assembly language to machine code. For the reverse translation, i.e., for translation from machine code to assembly language, the LFSA 200_2 is a receiving LFSA and the LFSA 200_1 is a generating LFSA.

By means of an example, consider again the assembly language instruction add r0, r1, 9. Upon receiving the string add “ ”, where the double quotes represent the space between the opcode add and the operand r0, the LFSA 200_1 makes a transition from the initial state 202_S to a state 202_2 along an edge 204_2. At the state 202_2 the operand r0 is received, and the LFSA 200_1 makes a transition to a state 202_4, along an edge 204_4. Next, a string, “ ” is received and the LFSA 200_1 makes a transition to a state 202_6, along an edge 204_6. The process continues until the LFSA 200_1 reaches the final state 202_F, thus the set of used transitions among the states of the LFSA 200_1 is as well as the immediate operand 9 are stored.

The generating LFSA 200_2 is activated and applies the stored set of used transitions among the states of the LFSA 200_1 and the stored immediate operand 9 via the bijective function, communicatively coupling the LFSA 200_1 with the LFSA 200_2. The LFSA 200_2 makes a transition from the initial state 206_S to a state 206_2 along an edge 208_2 resulting from applying the bijective function on the edge 204_2 and generates a binary string 0011. In the state 206_2 the immediate operand 9 is provided to the LFSA 200_2. The LFSA 200_2 makes a transition to a state 206_4 along an edge 208_4 resulting from applying the bijective function on the edge 204_F and generates a binary string 1001. The process continues until the LFSA 200_2 reaches the final state 206_F, thus generating the complete machine code instruction 0011100100000001.

However, more complex relations between the assembly language and machine code, e.g., immediate operand(s) split, pseudo-instruction(s), and other constructs known to person skilled in the art, limit the use of the two-way finite state automata communicatively coupled via a bijective function.

Accordingly, there is a need in the art for method and an apparatus, providing a solution to the above identified complex instruction relations, as well as providing additional advantages.

### SUMMARY

In an aspect of the disclosure, an apparatus and a method for instruction set translation according to appended independent claims is disclosed. Additional aspects are disclosed in the dependent claims.

### BRIEF DESCRIPTION OF THE DRAWINGS

The foregoing aspects described herein will become more readily apparent by reference to the following description when taken in conjunction with the accompanying drawings wherein:

FIG. 1 depicts a conceptual structure of a finite state transducer used as a translator in accordance with known aspects;

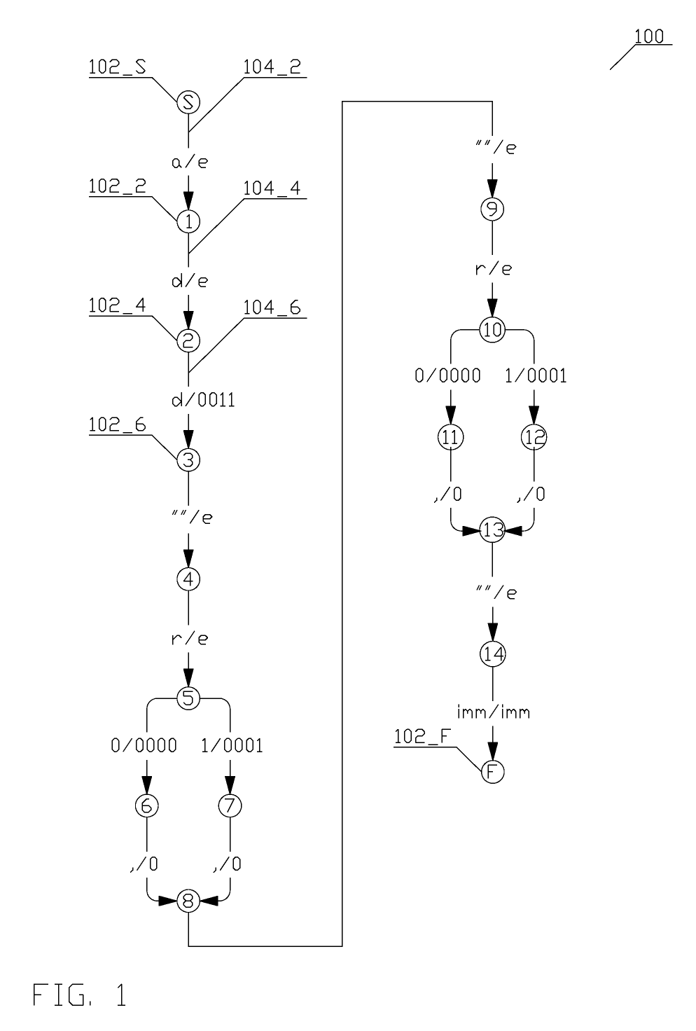

FIG. 2 depicts a conceptual structure of two lazy finite state automata communicatively coupled via a bijective function in accordance with known aspects;

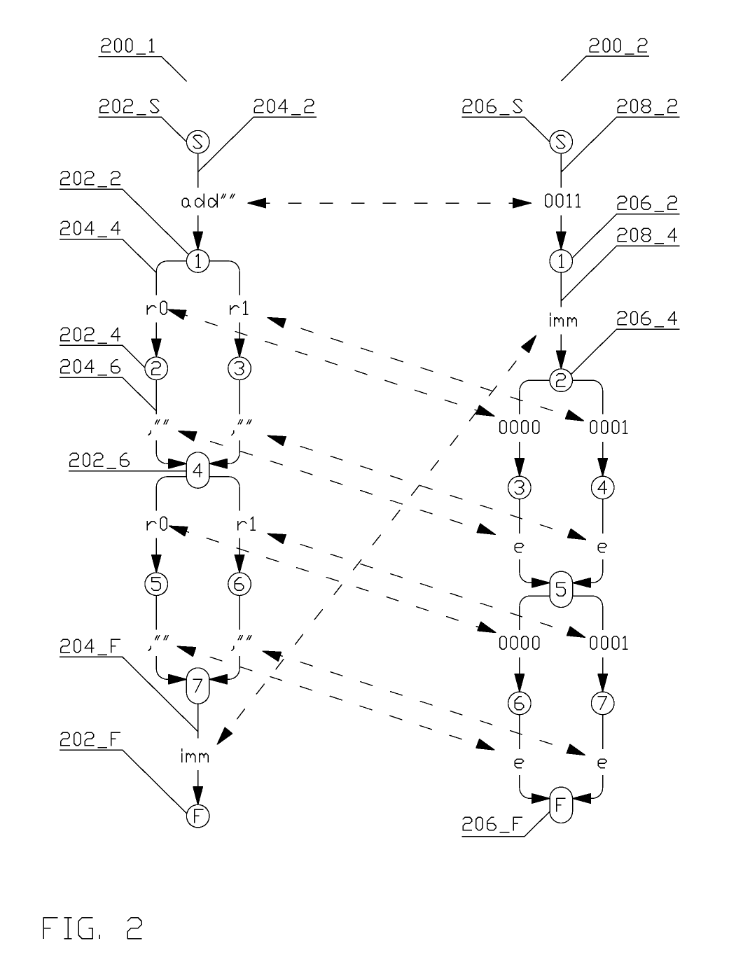

FIG. 3 depicts a conceptual structure of two lazy finite state automata communicatively coupled via a relation enabling operand splitting in accordance with an aspect of this disclosure; and

FIG. 4 depicts a conceptual structure of two lazy finite state automata communicatively coupled via a relation enabling pseudo-instructions in accordance with an aspect of this disclosure.

### DETAILED DESCRIPTION

Unless otherwise defined, all terms (including technical and scientific terms) used herein have the same meaning as commonly understood by a person having ordinary skill in the art to which this invention belongs. It will be further understood that terms, such as those defined in commonly used dictionaries, should be interpreted as having a meaning that is consistent with their meaning in the context of the relevant art and this disclosure.

As used herein, the singular forms “a,” an and the are intended to include the plural forms as well, unless the context clearly indicates otherwise. It will be further understood that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

Various disclosed aspects may be illustrated with reference to one or more exemplary configurations. As used herein, the term “exemplary” means “serving as an example, instance, or illustration,” and should not necessarily be construed as preferred or advantageous over other configurations disclosed herein.

Various aspects of the present invention will be described herein with reference to drawings that are schematic illustrations of conceptual configurations of the present invention, unless explicitly noted. The various aspects of this disclosure are provided to enable a person having ordinary skill in the art to practice the present invention. Modifications to various aspects of a presented throughout this disclosure will be readily apparent to a person having ordinary skill in the art, and the concepts disclosed herein may be extended to other applications.

The requirement to split immediate operand(s) is due to a need for optimal implementation of a hardware machine code instructions decoder, requiring that the decoder is fast and simple. Such an implementation is simplified when all instructions with an output operand store coding of the output operand into the same bit positions. Referring to Table 1, the first row shows a variant of an assembly language instruction add r0, r1, r2. The instruction adds together the content of structures r1, r2, and stores the result in structure r0. In an aspect, the structure comprises a register, i.e., an amount of storage (typically) addressed by mechanisms other than main memory, thus being accessed more quickly. However, as alluded to supra, the processor core may require different order of the operands in the machine code, e.g., receiving the operand r1 before the operand r0 as shown in the second row of Table 1.

TABLE 1

| Assembly language | add | r0 | r1 | r2 |
|---|---|---|---|---|
| instruction | | | | |
| Machine code instruction | 0 0 1 1 | 0 0 0 1 | 0 0 0 0 | 0 0 1 0 |
| Assembly language | load | | r1 | 0x99 |
| instruction | | | | |
| Machine code instruction | 1 1 0 0 | 1 0 0 1 | 0 0 0 1 | 1 0 0 1 |
| Bit position | 15 14 13 12 | 11 10 9 8 | 7 6 5 4 | 3 2 1 0 |

The result of the instruction's operation is stored into register r0 (output register), and coding of the register is stored at bits 7-4. Consequently, all other instructions having an output register should use bits 7-4 to store coding of the output register. To illustrate, consider now an assembly language instruction load r*, 0x99, where the symbol * stands for an integer number, thus indicating the particular register, e.g., r0, r1. The second operand is an address to a memory and the second operand is stored in 8 bits. As shown in the third row of Table 1, the instruction load r1, 0x99 stores the content of a memory at an address 0x99 in a register r1. However the address 0x99 comprises 8 bits. Because coding of register r1 must be stored at bits 7-4, the address is split into two 4-bit parts, and stored at bit positions 11-8 and 3-0, as shown in a binary representation of the machine code instruction in the fourth row of Table 1.

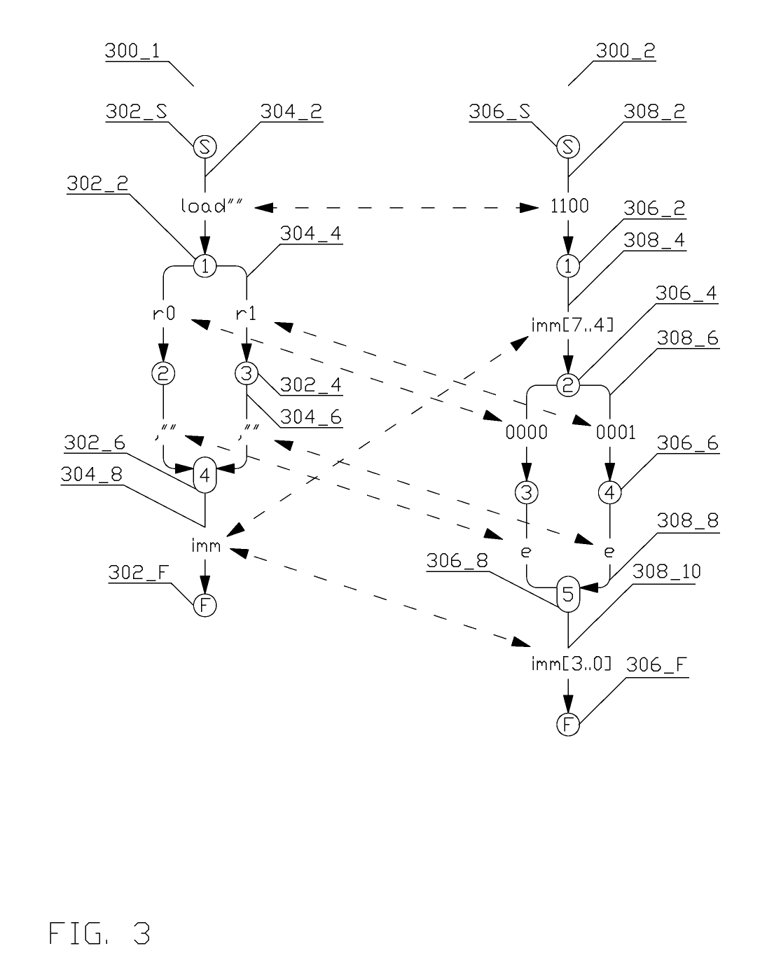

FIG. 3 depicts a conceptual structure for two lazy finite state automata communicatively coupled via a relation enabling immediate operand splitting. By means of an example, consider the assembly language instruction load r1, 0x99. Upon receiving the string load“ ”, where the double quotes represent the space between the opcode load and the operand r1, the LFSA 300_1 makes a transition from the initial state 302_S to a state 302_2 along an edge 304_2. At the state 302_2 the operand r1 is received, and the LFSA 300_1 makes a transition to a state 302_4, along an edge 304_4. Next, the string, “ ” is received and the LFSA 300_1 makes a transition to a state 302_6, along an edge 304_6. Next, the immediate operand 0x99 is received and the LFSA 300_1 makes a transition to the final state 302_F along an edge 304_8, thus the set of used transitions among the states in 300_1 as well as immediate operand 0x99 are stored.

The generating LFSA 300_2 is activated and applies the stored set of transitions among the states of the LFSA 300_1 and the stored immediate operand 0x99 via a relation, communicatively coupling the LFSA 300_1 with the LFSA 300_2. The relation is depicted by double-arrowed broken lines. Unlike the bijective function, the relation allows mapping of one edge to many edges. The LFSA 300_2 makes a transition from the initial state 306_S to a state 306_2 along an edge 308_2 resulting from applying the relation on the edge 304_2 and generates a binary string 1100. In the state 306_2 the immediate operand 0x99 is provided to the LFSA 300_2. The LFSA 300_2 makes a transition from the state 306_2 to a state 306_4 along an edge 308_4 resulting from applying the relation on the edge 304_8, and generates a binary string 1001, which corresponds to the first four bits of the address 0x99. In the state 306_4, the LFSA 300_2 makes a transition to a state 306_6 along an edge 308_6 resulting from applying the relation on the edge 304_4 and generates a binary string 0001. In the state 306_6, the LFSA 300_2 makes a transition to a state 306_8 along an edge 308_8 resulting from applying the relation on the edge 304_6 and generates an empty string e. In the state 306_8, the LFSA 300_2 makes a transition to the final state 306_F along an edge 308_10 resulting from applying the relation on the edge 304_8 and generates a binary string 1001, which corresponds to the last four bits of the address 0x99. Thus, by following the transitions among the states resulting from applying the stored set of transitions among the states of the LFSA 300_1 and the stored immediate operand 0x99 via the relation, the LFSA 300_2 generates the complete machine code instruction 1100100100011001.

The communicatively coupled two lazy finite state automata can also be used for a translation of a machine code to an assembly language. Consider a machine code represented by a binary string 1100100100011001, to be translated into an assembly language. The LFSA 300_2 receives in the initial state 306_S the four bits 1100 and makes a transition from the initial state 306_S to a state 306_2 along an edge 308_2. In the state 306_2 the four bits 1001 are received, and the LFSA 300_2 makes a transition to a state 306_4, along an edge 308_4 and the LFSA 302_2 stores 1001 as the first half of the immediate operand. In the state 306_4 the four bits 0001 are received, and the LFSA 300_2 makes a transition to a state 306_6, along an edge 308_6. In the state 306_6 an empty string e is received, and the LFSA 300_2 makes a transition to a state 306_8, along an edge 308_8. In the state 306_8 the four bits 1001 are received, and the LFSA 300_2 makes a transition to the final state 306_F, along an edge 308_10 and the LFSA 302_2 stores 1001 as the second half of the immediate operand. Thus the set of used transitions among the states in 300_2 is stored and the number 0x99, which is the value of binary string 10011001, corresponding to the immediate operand is stored.

The generating LFSA 300_1 is activated and applies the stored set of used transitions among the states of the LFSA 300_2 and the stored number 0x99 corresponding to the immediate operand via a relation, communicatively coupling the LFSA 300_2 with the LFSA 300_1. The LFSA 300_1 makes a transition from the initial state 302_S to a state 302_2 along an edge 304_2 resulting from applying the relation on the edge 308_2 and generates a string load“ ”. In the state 302_2, the LFSA 300_1 makes a transition to a state 302_4 along an edge 304_4 resulting from applying the relation on the edge 308_6 and generates a string r1. In the state 302_4, the LFSA 300_1 makes a transition to a state 302_6 along an edge 304_6 resulting from applying the relation on the edge 308_8 and generates a string, “ ”. Finally, the number 0x99 is provided to the LFSA 300_1 and the LFSA 300_1 makes a transition from the state 302_6 to the final state 302_F along an edge 304_8 resulting from applying the relation on the edges 308_4 and 308_10 and generates the number 0x99. The LFSA 300_1 thus generates the complete assembly language instruction load r1, 0x99. It can be observed, that one edge in the LFSA 300_1, i.e., 304_8, is in relation with two edges in the LFSA 300_2, i.e., 308_4 and 308_10. Therefore, unlike the bijective function, the relation allows mapping of one edge to a multiple of edges.

Another issue arises from the fact that an assembler may provide pseudo-instructions, which are not implemented as native processor core instructions, but the pseudo-instruction may comprise a shorthand for an instruction or the pseudo-instruction may be expanded into several machine code instructions to provide commonly needed functionality. By means of an example, the former will be explained. Referring to Table 2, the first row shows a variant of an assembly language instruction and r*, r*, r*, where the symbol * stands for an integer number, thus indicating the particular register, e.g., r0, r1. As disclosed, the assembly language instruction and r0, r0, r0 carries out bitwise and of the content of registers r0, r0, and stores the result in register r0. The binary representation of the machine code instruction is shown in the second row of Table 2.

TABLE 2

| Assembly language | and | r0 | r0 | r0 |
|---|---|---|---|---|
| instruction | | | | |
| Machine code instruction | 0 0 0 0 | 0 0 0 0 | 0 0 0 0 | 0 0 0 0 |
| Assembly language | nop | | | |
| instruction | | | | |
| Machine code instruction | 0 0 0 0 | 0 0 0 0 | 0 0 0 0 | 0 0 0 0 |
| Bit position | 15 14 13 12 | 11 10 9 8 | 7 6 5 4 | 3 2 1 0 |

It is clear that the instruction has no effect on the value stored in register r0. To shorten the assembly language instruction and, an assembly language instruction nop (no-operation), which takes no operands, is defined as shown in the third row of Table 2. The binary representation of the machine code instruction is shown in the fourth row of Table 2.

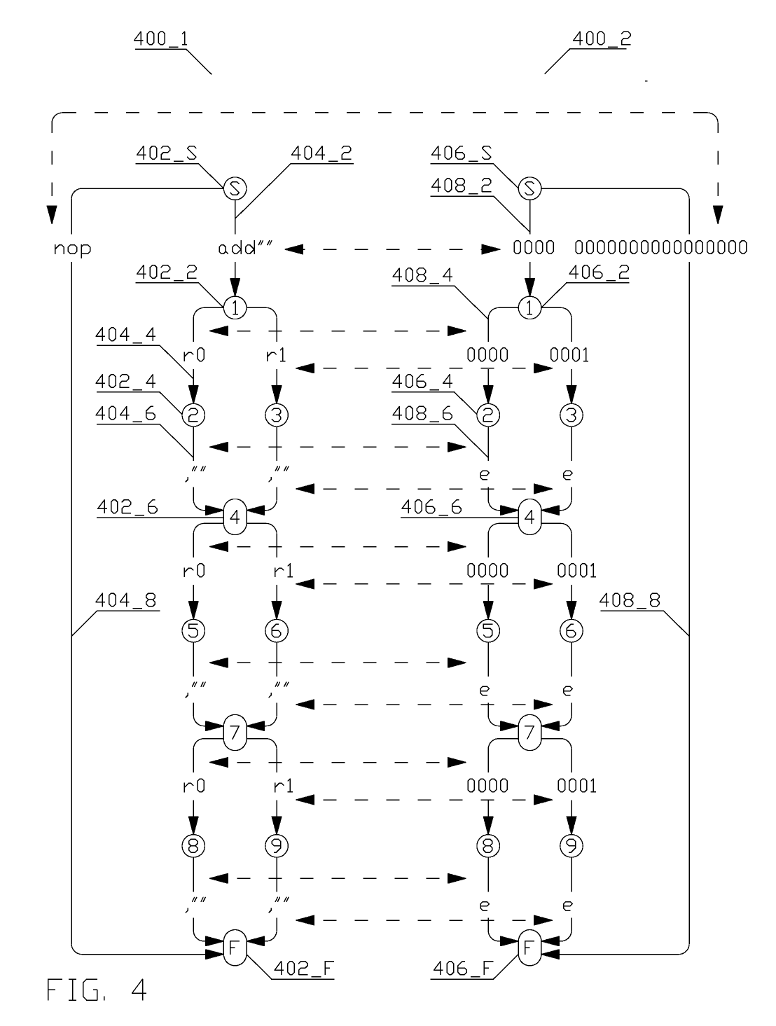

FIG. 4 depicts a conceptual structure of two lazy finite state automata communicatively coupled via a relation enabling pseudo-instructions. By means of an example, consider the assembly language instruction and r0, r0, r0 and the pseudo-instruction nop.

Considering first that the assembly language instruction and r0, r0, r0 was entered. The string and“ ”, where the double quotes represent the space between the opcode and and the first operand r0, is received and the LFSA 400_1 makes a transition from the initial state 402_S to a state 402_2 along an edge 404_2. At the state 402_2 the first operand r0 is received, and the LFSA 400_1 makes a transition to a state 402_4, along an edge 404_4. Next, the string, “ ” is received and the LFSA 400_1 makes a transition to a state 402_6, along an edge 404_6. The operation continues in the same manner till the final stage 402_F is reached, thus the set of used transitions among the states of the LFSA 400_1 is stored.

The generating LFSA 400_2 is activated and the stored set of used transitions among the states of the LFSA 400_1 is applied via a relation, communicatively coupling the LFSA 400_1 with the LFSA 400_2. The LFSA 400_2 makes a transition from the initial state 406_S to a state 406_2 along an edge 408_2 resulting from applying the relation on the edge 404_2 and generates a string 0000. In state 406_2, the LFSA 400_2 makes a transition to a state 406_4 along an edge 4084 resulting from applying the relation on the edge 404_4 and generates a binary string 0000. In state 406_4, the LFSA 400_2 makes a transition to a state 406_6 along an edge 408_6 resulting from applying the relation on the edge 404_6 and generates an empty string e. The operation continues in the same manner till the final stage 406_F is reached, and the string 0000000000000000 is generated.

Considering next that the assembly language instruction nop was entered. The string nop is received and the LFSA 400_1 makes a transition from the initial state 402_S to the final state 402_F along an edge 404_8, thus the set of used transitions among the states in 400_1 is stored.

The generating LFSA 400_2 is activated and the stored set of used transitions among the states of the LFSA 400_1 is applied via a relation, communicatively coupling the LFSA 400_1 with the LFSA 400_2. The LFSA 400_2 makes a transition from the initial state 406_S to the final state 406_F along an edge 408_8 resulting from applying the relation on the edge 404_8 and generates a string 0000000000000000.

For reverse translation, i.e., the translation of a machine code to an assembly language, the conceptual structure for two lazy finite state automata communicatively coupled with a relation must be different. In particular, as noted supra, the pseudo-instructions are not implemented in the processor core. Therefore, they are not considered during the translation of a machine code to an assembly language. The usage of transitions for pseudo-instructions is forbidden in LFSA for machine code. In particular, the edges 404_8 and 408_8 are forbidden and these edges are not considered during the translation. The reverse translation from machine code to assembly language itself is then carried out in the same manner as disclosed in regards to FIG. 3 and associated text supra. Consequently, the binary string 0000000000000000 is always translated to an assembly language instruction and r0, r0, r0.

The various aspects of this disclosure are provided to enable a person having ordinary skill in the art to practice the present invention. Various modifications to these aspects will be readily apparent to persons of ordinary skill in the art, and the concepts disclosed therein may be applied to other aspects without departing from the spirit or scope of the invention. Thus, the present invention is not intended to be limited to the aspects shown herein but is to be accorded the widest scope consistent with the principles and novel features disclosed herein. By means of an example, although the aspects were disclosed in terms of lazy finite state automata, it is well know that the lazy finite state automata may be converted to finite state automata and vice versa; consequently, the disclosure is equally applicable to finite state automata. By means of another example, although the operand splitting was disclosed in terms of an immediate operand, a person of ordinary skills in the art will be able to apply the disclosed concepts to any operand, i.e., an output register operand.

All structural and functional equivalents to the various illustrative logical blocks, modules, circuits, and algorithm steps described in connection with the various aspects described throughout this disclosure that are known or later come to be known to those of ordinary skill in the art are expressly incorporated herein by reference and are intended to be encompassed by the claims. Such illustrative logical blocks, modules, circuits, and algorithm steps may be implemented as electronic hardware, computer software, or combinations of both.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Moreover, nothing disclosed herein is intended to be dedicated to the public regardless of whether such disclosure is explicitly recited in the claims. No claim element is to be construed under the provisions of 35 U.S.3. §112, sixth paragraph, unless the element is expressly recited using the phrase “means for” or, in the case of a method claim, the element is recited using the phrase “step for.”

What is claimed is:

1. A method for instruction translation, comprising:
providing a first finite state automaton;
providing a second finite state automaton communicatively coupled with the first finite state automaton via a one-to-many relation; and
providing the instruction to be translated to one of the first or the second finite state automaton; and
receiving a translated instruction from the other of the first or the second finite state automaton.

2. The method as claimed in claim 1, further comprising:
activating the one of the first or the second finite state automaton.

3. The method as claimed in claim 2, wherein the activated one of the first or the second finite state automaton stores a set of used transitions among the states of the activated one of the first or the second finite state automaton in accordance with the provided instruction.

4. The method as claimed in claim 3, wherein the activated one of the first or the second finite state automaton further stores at least one operand.

5. The method as claimed in claim 2, further comprising:
activating the other of the first or the second finite state automaton when the activated one of the first or the second finite state automaton transitions to the final state.

6. The method as claimed in claim 5, wherein the activated other of the first or the second finite state automaton generates the translated instruction by following transitions resulting from applying the set of used transitions stored by the one of the first or the second finite state automaton via the one-to-many relation.

7. The method as claimed in claim 5, wherein the activated other of the first or the second finite state automaton generates the translated instruction by following transitions resulting from applying at least one operand and the set of used transitions stored by the one of the first or the second finite state automaton via the one-to-many relation.

8. The method as claimed in claim 1, wherein one-to-many relation comprises:
a relation mapping at least one transition of the first finite state automaton to more than one transition of the second finite state automaton.

9. The method as claimed in claim 1, wherein the providing the instruction to be translated to the first or to the second finite state automaton comprises:
providing the instruction to be translated to the first finite state automaton when the instruction comprises an assembly language instruction.

10. The method as claimed in claim 1, wherein the providing the instruction to be translated to the first or to the second finite state automaton comprises:
providing the instruction to be translated to the second finite state automaton when the instruction comprises a machine code instruction.

11. The method as claimed in claim 1, wherein the first and the second finite state automaton comprise lazy finite state automata.

12. An apparatus for instruction translation, comprising:
a first finite state automaton; and
a second finite state automaton communicatively coupled with the first finite state automaton via a one-to-many relation; wherein
the instruction to be translated is provided to one of the first or the second finite state automaton; and
a translated instruction is received from the other of the first or the second finite state automaton.

13. The apparatus as claimed in claim 12, wherein the one of the first or the second finite state automaton is activated

14. The apparatus as claimed in claim 13, wherein the activated one of the first or the second finite state automaton stores a set of used transitions among the states of the activated one of the first or the second finite state automaton in accordance with the provided instruction.

15. The apparatus as claimed in claim 14, wherein the activated one of the first or the second finite state automaton further stores at least one operand

16. The apparatus as claimed in claim 13, wherein the other of the first or the second finite state automaton is activated when the activated one of the first or the second finite state automaton arrives to the final state.

17. The apparatus as claimed in claim 16, wherein the activated other of the first or the second finite state automaton generates the translated instruction by following transitions resulting from applying the set of used transitions stored by the one of the first or the second finite state automaton via the one-to-many relation.

18. The apparatus as claimed in claim 16, wherein the activated other of the first or the second finite state automaton generates the translated instruction by following transitions resulting from applying at least one operand and the set of used transitions stored by the one of the first or the second finite state automaton via the one-to-many relation.

19. The apparatus as claimed in claim 12, wherein the one-to-many relation maps at least one transition of the first finite state automaton to one or more transitions of the second finite state automaton.

20. The apparatus as claimed in claim 12, wherein the instruction to be translated is provided to the first finite state automaton when the instruction comprises an assembly language instruction.

21. The apparatus as claimed in claim 12, wherein the instruction to be translated is provided to the second finite state automaton when the instruction comprises a machine code instruction.

22. The apparatus as claimed in claim 12, wherein the first and the second finite state automaton comprise lazy finite state automata.
